(19) United States
(12) Patent Application Publication
(10) Pub. No.: US 2026/0268555 A1
(43) Pub. Date: Sep. 10, 2026

(54) IMAGE PROCESSING APPARATUS AND METHOD, IMAGE CAPTURING APPARATUS, AND STORAGE MEDIUM

(71) Applicant: CANON KABUSHIKI KAISHA, Tokyo (JP)

(72) Inventor: SATOSHI SHODA, Tochigi (JP)

(21) Appl. No.: 19/550,431

(22) Filed: Feb. 26, 2026

(30) Foreign Application Priority Data
Mar. 7, 2025 (JP) 2025-036695

(51) Int. Cl. G06T 11/60; G06T 7/50; H04N 23/63

(52) U.S. Cl. CPC G06T 11/60; G06T 7/50; H04N 23/632; G06T 2207/10028

(57) ABSTRACT

An image processing apparatus comprises: a generating unit that generates first instruction information for instructing object editing with respect to an image; an editing unit that performs object editing based on the first instruction information with respect to first image data, and generates second image data; and an updating unit that updates first map data corresponding to the first image data so as to correspond to the second image data generated by the editing unit.

### BACKGROUND

### Field of the Technology

The present disclosure relates to an image processing apparatus and method, an image capturing apparatus, a program and a storage medium, and, in particular, to a technology for automatically updating map data following object editing of a digital image.

### Description of the Related Art

In recent years, technologies for storing map data such as depth maps and distance maps in image files have been widely utilized in digital image processing. Such data is useful in 3D rendering and image analysis, but when object editing is performed on an image, the corresponding map data also needs modifying. Japanese Patent Laid-Open No. 2023-85325 illustrates a technology for efficiently handling depth information by storing image metadata including a main image and a depth map in a file container.

Japanese Patent Laid-Open No. 2023-85325 is an example of related art.

The technology described in Japanese Patent Laid-Open No. 2023-85325 discloses performing a cropping or resizing operation on the main image and updating the depth map according to the cropped or resized image. However, updating depth information following an operation for changing (e.g., adding, removing, moving, modifying, etc.) an object within an image is not taken into consideration.

### SUMMARY

The present disclosure has been made in consideration of the above situation, and, when a user performs object editing on an image, map data that corresponds to the edited image is automatically updated.

The present disclosure in its aspect provides an image processing apparatus comprising: a generating unit that generates first instruction information for instructing object editing with respect to an image; an editing unit that performs object editing based on the first instruction information with respect to first image data, and generates second image data; and an updating unit that updates first map data corresponding to the first image data so as to correspond to the second image data generated by the editing unit.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing the configuration of an image processing apparatus in a first embodiment of the present disclosure.

FIG. 2 is a flowchart showing object editing processing in the first embodiment.

FIG. 3 is a diagram showing an image of a first image file and a map image of a corresponding depth map in the first embodiment.

FIG. 4 is a diagram showing an example of object editing prompts in the first embodiment.

FIG. 5 is a schematic diagram showing an example of an image before object editing and images after editing processing for each type of object editing processing in the first embodiment.

FIG. 6 is a diagram showing an image of a second image file and a map image of a depth map in the first embodiment.

FIG. 7 is a diagram showing an example of a depth map updating prompt in the first embodiment.

FIG. 8 is a diagram showing an image of a third image file and a map image of a corresponding depth map in the first embodiment.

FIG. 9 is a flowchart showing object editing processing in a second embodiment.

FIG. 10 is a diagram showing an example of an object editing prompt in the second embodiment.

FIG. 11 is a flowchart showing object editing processing in a third embodiment.

FIG. 12 is a diagram showing an example of a depth map updating prompt in the third embodiment.

FIG. 13 is a schematic diagram showing example display by a display unit during object editing.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

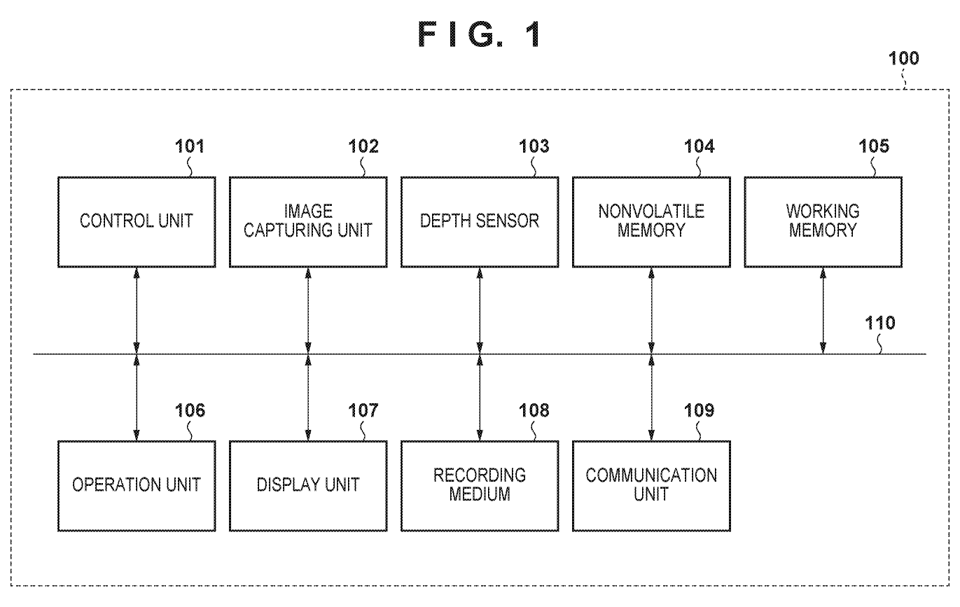

FIG. 1 is a block diagram showing an example configuration of a digital camera 100, which is an example of an image processing apparatus of the present embodiment. Note that, herein, a digital camera is described as an example of the image processing apparatus, but the image processing apparatus of the present disclosure is not limited thereto, and the technology disclosed herein is applicable to various electronic devices that can be provided with an image processing function. Examples of such devices include an information processing apparatus such as a smartphone, a tablet device, or a personal computer, and an image capturing apparatus such as a mobile phone with a camera.

As shown in FIG. 1, the digital camera 100 is constituted including a control unit 101, an image capturing unit 102, a depth sensor 103, a nonvolatile memory 104, a working memory 105, an operation unit 106, a display unit 107, a recording medium 108, and a communication unit 109. These units are able to exchange data with each other via a bus 110.

The control unit 101 controls the units of the digital camera 100 in accordance with signals input thereto and programs described later. Note that, instead of the control unit 101 controlling the entirety of the digital camera 100, the entire digital camera 100 may be controlled by multiple pieces of hardware sharing the processing.

The image capturing unit 102 converts subject light formed as an image by the lens into electrical signals using an image sensor, and further converts the electrical signals into digital data and outputs the digital data as image data. Note that the lens may be integrated with the digital camera 100 or may be removable. The image data output from the image capturing unit 102 is stored in the working memory 105.

The depth sensor 103 is a Time of Flight (TOF) sensor, and is able to acquire the distance from the digital camera 100 to each subject within the angle of view, by measuring the time taken for light emitted from a light source to be reflected back by an object. Note that the depth sensor 103 is not limited to a TOF sensor, and an image sensor included in the image capturing unit 102 may be used therefor. In that case, the distance to a subject is measured by disposing a plurality of image sensors in the image capturing unit 102 such that image capturing surfaces thereof are arranged in the same plane, and detecting deviation between a plurality of images having parallax obtained from these image sensors. Also, as another example that uses an image sensor, a configuration is adopted in which each of a plurality of pixels constituting the image sensor has a plurality of photoelectric conversion units, and the distance to a subject is measured by generating a plurality of images having parallax using signals from the photoelectric conversion units and detecting deviation between the images.

Based on a control command from the control unit 101, the depth sensor 103 acquires the distance to the subject at the timing at which the image capturing unit 102 captures an image, generates a depth map corresponding to the image, and holds the depth map in the working memory 105. The control unit 101 stores the depth map held in the working memory 105 in a metadata area of image data to be output by the image capturing unit 102 and records the depth map to the recording medium 108.

The nonvolatile memory 104 is a nonvolatile memory that is electrically erasable and recordable, and stores programs described later that are executed by the control unit 101, an image generation AI model, and the like.

The working memory 105 is used as a buffer memory for temporarily holding image data captured by the image capturing unit 102 and depth maps generated by the depth sensor 103, an image display memory of the display unit 107, a working area of the control unit 101, and the like.

The operation unit 106 is used in order to receive instructions to the digital camera 100 from a user. For example, the operation unit 106 includes operation members such as a power button for the user to instruct ON/OFF of power supply to the digital camera 100, a release switch for instructing image capture, and a playback button for instructing playback of image data. The operation unit 106 also includes a touch panel formed on the display unit 107 described later. Note that the release switch has a first switch SW1 and a second switch SW2. The SW1 is turned ON by the release switch entering a first state, such as a so-called half-pressed state. An instruction for performing preparatory processing for image capturing such as autofocus (AF) processing, automatic exposure (AE) processing, auto white balance (AWB) processing, and electronic flash (EF) processing is thereby received. Also, the second switch SW2 is turned ON by the release switch entering a second state, such as a so-called fully pressed state. An instruction for performing image capturing is thereby received. The operation unit 106 also functions as a UI for the user to instruct object editing contents on a predetermined image, in cooperation with the display unit 107 described later.

The display unit 107 displays a viewfinder image during image capture, displays captured image data, displays text for interactive operations, and displays an image or a UI during object editing. Note that the display unit 107 need not necessarily be equipped with the digital camera 100, and the digital camera 100 can be connected to the display unit 107 and need only have at least a display control function of controlling display of the display unit 107.

The recording medium 108 is able to record image data generated within the digital camera 100 and image data acquired via the communication unit 109 described below. The recording medium 108 may be configured to be removable from the digital camera 100 or may be integrated into the digital camera 100. That is, the digital camera 100 need only have at least a function of accessing the recording medium 108.

The communication unit 109 is an interface for connecting to an external device. The digital camera 100 of the present embodiment is able to exchange data with the external device via the communication unit 109. Note that, in the present embodiment, the communication unit 109 is an antenna, and the control unit 101 can be connected to the external device via the antenna. As a protocol for data communication, Picture Transfer Protocol over Internet Protocol (PTP/IP) through wireless LAN, for example, can be used. Note that communication with the digital camera 100 is not limited thereto. For example, the communication unit 109 can include an infrared communication module, a Bluetooth (registered trademark) communication module, and a wireless communication module such as Wireless USB. Furthermore, a wired connection such as a USB cable, an HDMI (registered trademark) cable, or an IEEE 1394 cable may be employed. Also, the digital camera 100 is able to acquire image files generated by the external device via the communication unit 109.

Next, a series of processing for object editing in the present embodiment will be described.

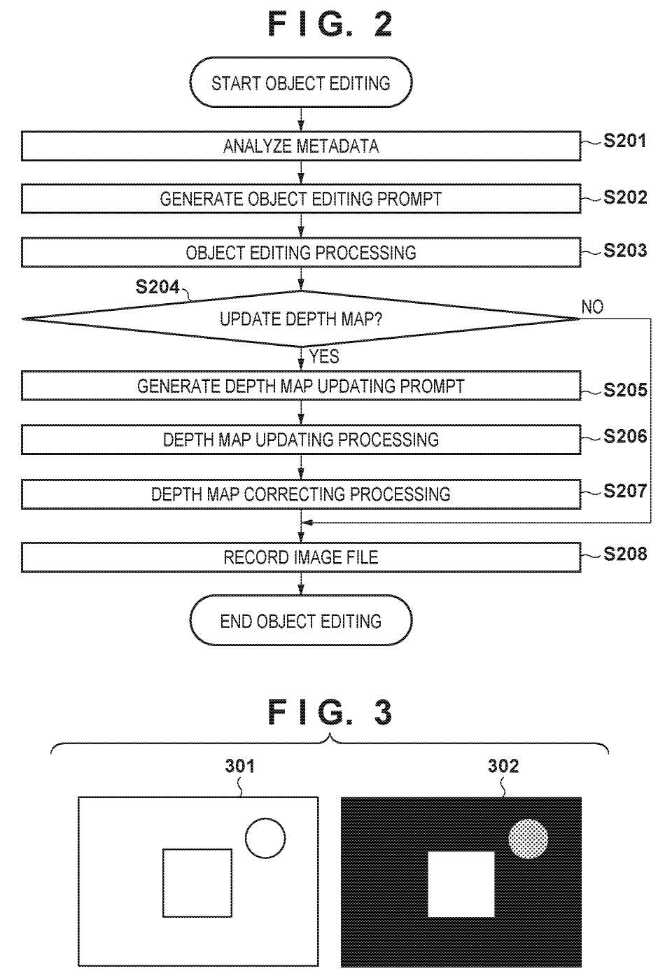

FIG. 2 is a flowchart showing a series of processing for object editing in the digital camera 100, with the processing being realized by the control unit 101 executing a program saved in advance to the nonvolatile memory 104. Also, in the following description, intermediate data that is handled in each step is assumed to be held in the working memory 105, and the control unit 101 is assumed to be able to freely access this data.

Also, the processing of this flowchart is started in response to reception of an instruction for performing an editing operation on a specific image, with an image list being displayed on the display unit 107 by the user, for example. The listed images referred to here are images captured by the image capturing unit 102, images acquired from the external device via the communication unit 109, images read out from the recording medium 108, and the like, and are temporarily held in the working memory 105.

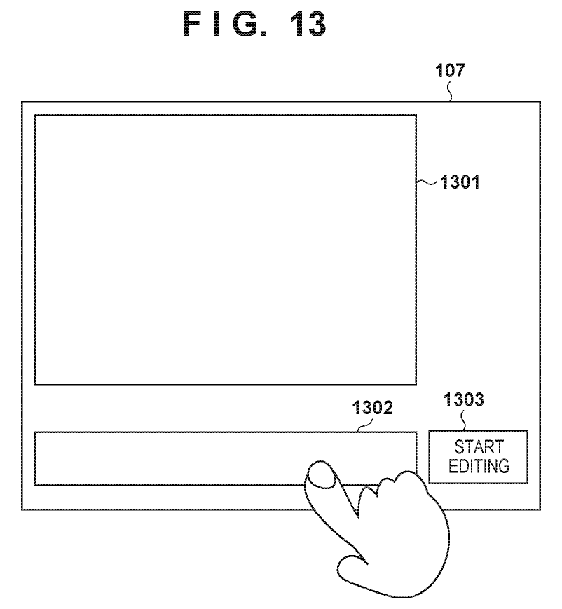

Also, the user is able to input object editing contents via a user interface (UI) such as shown in FIG. 13. As shown in FIG. 13, an area 1301 for displaying an image, a text box 1302 that allows text input of object editing contents by the user, and an object editing start button 1303 are disposed on the display unit 107. As a result of the user touching the text box 1302, a software keyboard not shown is displayed on the display unit 107, and it is possible to set object editing contents according to input using the software keyboard. Also, object editing processing is started by the user pressing the object editing start button 1303.

Note that the method of inputting object editing contents is not limited to inputting characters with a keyboard or the like, and input may be performed using a well-known input method such as voice input or gaze input, in which case the operation unit 106 need only be constituted by required operation members.

First, in step S201, the control unit 101 reads out an image file (first image file) selected from the working memory 105 and analyzes metadata information to acquire file structure information and data format information of a depth map. The file structure information is information that indicates a header, metadata, and a storage area of image data, and includes information capable of uniquely specifying at least image name, image size, and storage location and size of the depth map in the metadata area. The data format information of the depth map includes a bit depth of the depth map and information associating depths and values.

Here, the data format of a depth map will be described, with reference to FIG. 3.

FIG. 3 is a diagram showing an example of an image 301 that is based on image data (first image data) stored in a first image file and a map image 302 that conceptually shows a depth map (first depth map). The map image 302 represents map data indicating the depth of each pixel of the image 301, and, here, has an 8-bit value of each pixel, and represents depth in grayscale. Note that, in the map image 302, closer to white (255) indicates closer to the camera, and closer to black (0) indicates further from the camera.

Note that the data format of the depth map is not limited to the above-described format, and there are depth maps with various data formats.

In step S202, the control unit 101 generates an object editing prompt. Specifically, a prompt (first instruction information) in a format understandable to the image generation AI that is utilized in object editing processing described later is generated, based on the object editing contents and the file structure information. Specifically, the control unit 101 generates a prompt by reflecting information that is based on acquired information in a template prepared in advance.

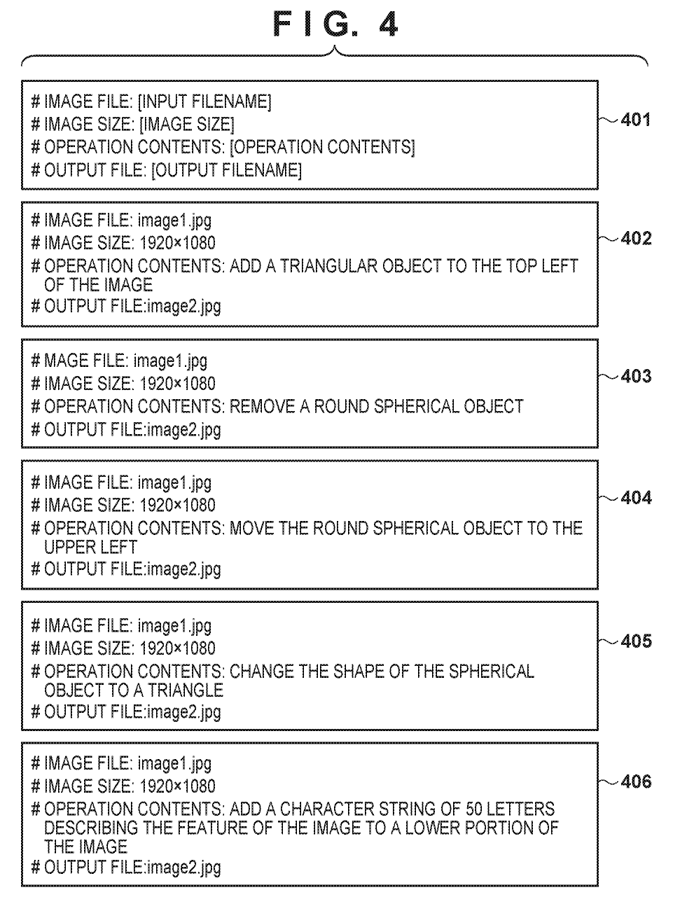

FIG. 4 shows an example of an object editing prompt for each type of object editing processing. FIG. 4 illustrates, in order from the top, a template 401 and object editing prompts 402 to 406 that are generated in the case of adding an object, removing an object, moving an object, correcting an object, and adding an effect object.

Within the template 401 for the object editing prompts are a plurality of fields enclosed by square brackets [], and the control unit 101 generates object editing processing prompts for instructing various editing processing, by replacing the contents of each field. Hereinafter, the various items in the template 401 and the method of replacing the fields will be described.

“# image file” is the filename of the image file that is input. The control unit 101 replaces the [input filename] field with the filename of the first image file.

“# image size” is the image size of the image data that is input. The control unit 101 replaces the [image size] field, based on the image size information of the first image file obtained in the metadata analysis processing.

“# operation contents” is an instruction relating to the object editing contents. The control unit 101 replaces the [operation contents] field with a character string that is input to the text box 1302 displayed on the display unit 107.

“# output file” is the output filename. The control unit 101 replaces the [output filename] field with the output filename. The output filename is determined by, for example, incrementing a number appended to the input filename. Note that the naming convention of the output file is not limited thereto. For example, in cases such as handling a file without an appended number, a unique output filename may be generated by automatically appending a date-time or a number.

The input/output filenames and image size are treated as auxiliary information during file access and image processing. The operation contents are referred to as a detailed instruction of the editing contents during object editing.

Examples of prompts that reflect specific information in the template 401 are the five prompts 402 to 406. Here, an example is shown in which the first image file “image1.jpg” with an image size of 1920×1080 pixels is given as the input image.

Also, in the above description, a character string that is input to a text box is directly reflected in the prompt as operation contents, but the character string in the text box can be changed, according to the generative model for performing downstream object editing. For example, in the case of using a generative model that expects a prompt in which processing contents that do not correspond to natural language are separated with a comma, processing for breaking down the character string in the text box into comma-separated elements may be performed and the comma-separated elements may be reflected in the prompt.

In step S203, the control unit 101 inputs the object editing prompt (first instruction information) and the first image file generated in step S202 to the image generation AI stored in advance in the nonvolatile memory 104. A second image file is then generated by performing object editing processing on the first image data stored in the first image file to generate second image data and replacing the first image data of the first image file with the second image data. The image generation AI can be realized by generative models such as Generative Adversarial Network (GAN) and Variational Autoencoder (VAE).

FIG. 5 is a schematic diagram showing example images that are based on image data before and after object editing, for each type of object editing processing. The image 301 shows an example of an image of the first image data before editing that is included in the first image file, and corresponds to the image 301 in FIG. 3. Also, in FIG. 5, the area enclosed by the dotted line indicates the area where the existing object in the image before editing has disappeared, that is, the area targeted for interpolation processing.

In the case where object addition processing is instructed, a virtual object having the feature described in the prompt is inserted in a designated position of the image. For example, if the prompt 402 in FIG. 4 is input, the image generation AI adds a triangular object to the top left of the image so as to not overlap with the square object, and performs correction to fit in with the background, as shown in an image 502.

If object removal processing is instructed, an existing object described in the prompt is removed and interpolation is performed such that the area from which the existing object was removed does not look unnatural. For example, if the prompt 403 in FIG. 4 is input, the image generation AI removes a round spherical object, and performs interpolation such that the background looks natural, as shown in an image 503.

If object movement processing is instructed, an existing object described in the prompt is removed, and interpolation is performed such that the area from which the object was removed does not appear unnatural, and the existing object that was removed is inserted in a designated position. For example, if the prompt 404 in FIG. 4 is input, the image generation AI moves the round spherical object to the upper left and performs interpolation processing such that the background of the area where the round spherical object was located looks natural, as shown in an image 504.

If object modification processing is instructed, processing is performed on the existing object described in the prompt to change the texture or correct the object based on the modification contents described in the prompt. For example, if the prompt 405 in FIG. 4 is input, the image generation AI changes the shape of the spherical object to a triangle and performs interpolation such that the background looks natural, as shown in an image 505.

If addition of an effect object is instructed, an effect object generated based on the instruction described in the prompt is superimposed on the image. For example, if the prompt 406 in FIG. 4 is input, the image generation AI adds a character string describing the image to a lower portion of the image, as shown in an image 506. An effect object is an object that does not have depth such as a stamp or a character, and the depth map does not need updating.

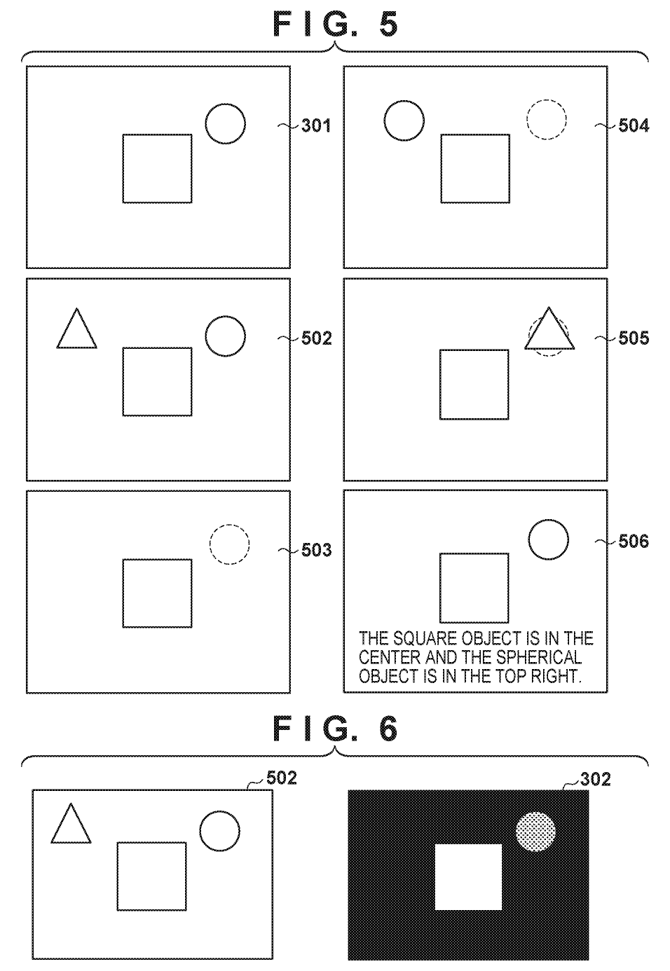

FIG. 6 is a diagram showing the relationship between image data stored in the second image file generated in step S203 and the depth map, and shows an image that is based on the second image data and a map image that conceptually shows the first depth map. As an example, FIG. 6 shows the image 502 shown in FIG. 5 that is obtained as a result of performing object addition processing on the image 301 included in the first image file, based on the prompt 402 shown in FIG. 4. As shown in FIG. 6, in the second image file, the change following object editing on the image 502 is not reflected in the depth map, and thus the map image remains unchanged from the map image 302 shown in FIG. 3, which corresponds to the first depth map.

In step S204, the control unit 101 determines whether the depth map needs updating. Specifically, if only object editing processing relating to an effect object that does not have depth such as a stamp or a character is performed, it is determined that the depth map does not need updating, and if object editing processing other than object editing processing relating to an effect object is performed, it is determined that the depth map needs updating. If the depth map needs updating, the processing advances to step S205, and if the depth map does not need updating, the processing advances to step S208.

In step S205, the control unit 101 generates a depth map updating prompt (second instruction information), based on the file structure information including the storage location of the depth map and the data format information of the depth map that were analyzed in step S201. Specifically, the control unit 101 generates prompts by reflecting information that is based on acquired information in a template prepared in advance.

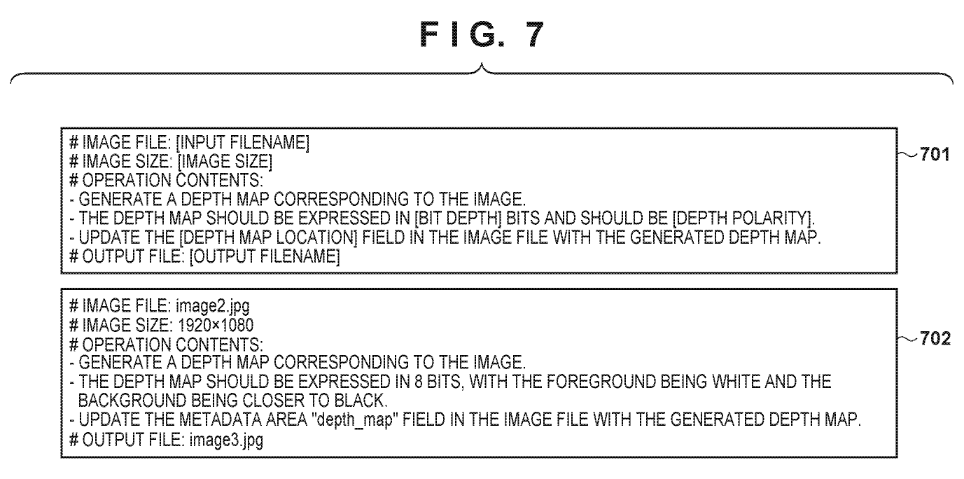

FIG. 7 shows an example of a depth map updating prompt.

In FIG. 7, there are a plurality of fields enclosed by square brackets [] within a template 701 for the depth map updating prompt, and the control unit 101 generates the depth map updating prompt by replacing the contents of each field. Hereinafter, the various items in the template 701 and the method of replacing the fields will be described in detail.

“# image file” is the filename of the image file that is input. The control unit 101 replaces the [input filename] field with the filename of the second image file.

“# image size” is the image size of the image data that is input. The control unit 101 replaces the [image size] field, based on the image size information of the second image file obtained in the metadata analysis processing.

“# operation contents” is an instruction to generate a depth map. The control unit 101 replaces the “bit depth” field with the bit depth of the depth map, based on the depth map data format obtained in the metadata analysis processing. Also, the control unit 101 replaces the [depth polarity] field with text that indicates polarity information of the depth similarly specified by the depth map data format. Furthermore, the control unit 101 replaces the “depth map storage location” field with a tag name, which is the depth map storage location included in the file structure information.

“# output file” is the output filename. The control unit 101 replaces the “output filename” field with the output filename. The output filename is determined by, for example, incrementing a number appended to the input filename. Note that the naming convention of the output file is not limited thereto. For example, in cases such as when handling a file without an appended number, a unique output filename may be generated by automatically appending a date-time or a number.

An example of a prompt obtained by reflecting specific information in the template 701 is a prompt 702. Here, an example is shown in which a second image file “image2.jpg” having an image size of 1920×1080 pixels is given as the input image file. The depth map is stored in a depth_map field of the metadata area of the input image file. Also, the depth map has the data format illustrated in FIG. 3.

In step S206, the control unit 101 generates a new depth map (second depth map) corresponding to the second image data stored in the second image file, based on the data format information of the depth map reflected in the depth map updating prompt. Furthermore, the control unit 101 generates an image file (third image file) in which the depth map is changed in correspondence with object editing, by replacing the first depth map in the second image file with the generated second depth map, based on the file structure information reflected in the depth map updating prompt.

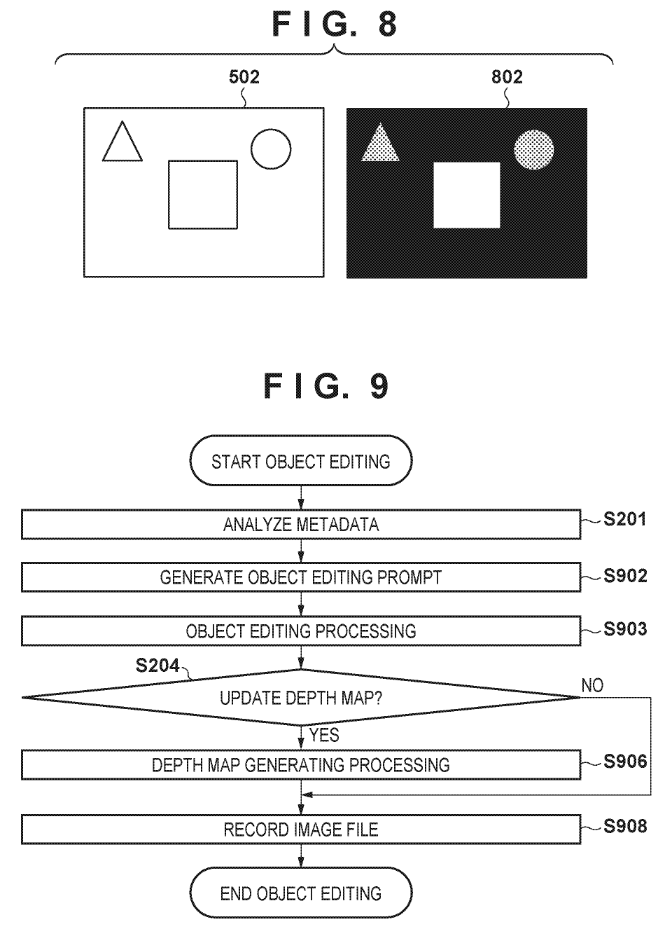

FIG. 8 is a diagram showing the relationship between the image data stored in the third image file generated in step S206 and the depth map, and shows an image that is based on the image data and a map image that conceptually shows the depth map. As shown in FIG. 8, a map image 802 obtained in the processing for generating the second depth map in step S206 corresponds to the image 502 of the second image data included in the second image file, and is a map image obtained by reflecting the change resulting from object editing in the depth map.

In step S207, the control unit 101 compares the first image file with the third image file and generates an image file (fourth image file) in which the depth map is corrected.

At this time, the control unit 101 detects the area targeted for object editing, by comparing the first image data stored in the first image file with the second image data stored in the third image file on a pixel-by-pixel basis. More specifically, corresponding pixels in the first image data and the second image data are compared and mask data (area data) in which 1 is assigned to pixel positions with different pixel values and 0 is assigned to pixel positions with the same pixel values is generated. Mask data can be treated as a map that determines whether each pixel of an image is an area that has undergone object editing.

The control unit 101 then applies the values of the corresponding pixel positions of the first depth map of the first image file to the pixels whose mask data is 0, that is, the pixels that have not undergone object editing. On the other hand, the control unit 101 applies the values of the corresponding pixel positions of the second depth map of the third image file to the pixels whose mask data is 1, that is, the pixels that have undergone object editing. In this way, a third depth map, obtained by correcting the first depth map, is generated, by applying the values of the first depth map or the second depth map based on the mask data on a pixel-by-pixel basis. By replacing the second depth map of the third image file with the third depth map generated in this way, a fourth image file in which the second image data that has undergone object editing and the third depth map that reflects the object editing are stored is generated.

In step S208, the control unit 101 records an image file on which object editing processing has been performed to the recording medium 108. Specifically, if the depth map is updated, the fourth image file is recorded, and if the depth map is not updated, the second image file is recorded.

When the image file is recorded to the recording medium 108, the series of processing for object editing is ended.

According to the first embodiment as described above, it becomes possible to automatically update the map data when the user edits an object in an image.

For example, when the user inputs an instruction such as “move the tree to the right,” the image generation AI changes the position of the tree based on the instruction, and the depth map is also automatically updated. This process enables the time and hassle of manual editing to be greatly reduced.

Furthermore, through the depth map correction processing, an accurate depth map is generated by detecting the difference in image data before and after object editing and integrating the depth maps based on the difference. Erroneous depth map updates that occur in areas where object editing has not been performed can thereby be cancelled, and these areas can be reverted to the correct values.

Note that, in the present embodiment, updating of a depth map is described as an example for illustrative purposes, but the present disclosure is configured to enable map data to be updated by providing a file structure and a map data format, and thus is applicable to data in various map formats other than depth maps, such as distance maps, normal maps, and segmentation maps.

### Second Embodiment

Next, a second embodiment of the present disclosure will be described.

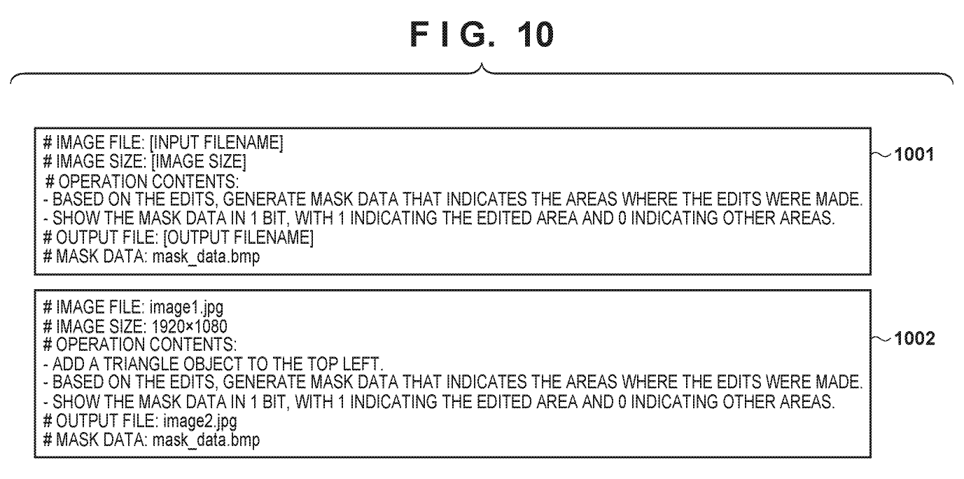

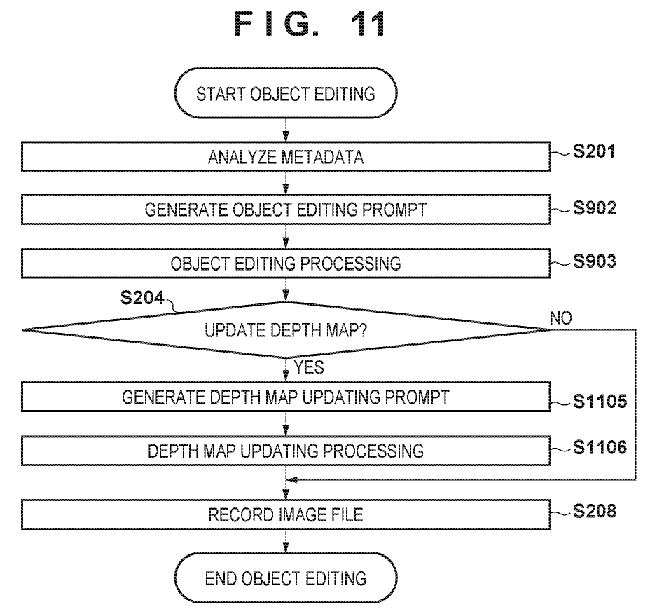

An example of a digital camera 100 in the second embodiment will be described, with reference to FIGS. 9 and 10, focusing on the differences from the first embodiment. Note that since the configuration of the digital camera 100 in the second embodiment is similar to that described with reference to FIG. 1 in the first embodiment, description thereof is omitted. The second embodiment differs from the first embodiment in that a depth estimation model that does not require a prompt to update the depth map is used, and in that the update area of the depth map is limited.

FIG. 9 is a flowchart showing a series of processing for object editing in the digital camera 100, with the processing being realized by the control unit 101 executing a program saved in advance to the nonvolatile memory 104. Also, in the following description, intermediate data that is handled in each step is assumed to be held in the working memory 105, and the control unit 101 is assumed to be able to freely access this data. Also, the same step numbers are given to processing that is the same as the processing shown in FIG. 2 described in the first embodiment, and description thereof is omitted.

In step S902, the control unit 101 generates an object editing prompt. FIG. 10 shows an example of an object editing prompt in the second embodiment.

In FIG. 10, reference numeral 1001 denotes an example of a template for an object editing prompt, and reference numeral 1002 denotes an example of a prompt obtained by reflecting the processing contents in the template 1001. Compared to the template 401 shown in FIG. 4, in the template 1001 of the second embodiment, an instruction to output mask data indicating the object editing area is included in advance in the “operation contents” field. The object editing prompt 1002 thereby instructs processing for “adding a triangular object in the upper left” and “generating mask data indicating the area where editing was performed”.

In step S903, the control unit 101 inputs the object editing prompt (first instruction information) generated in step S902 and the first image file to the image generation AI stored in advance in the nonvolatile memory 104. The control unit 101 then generates a second image file by performing object editing processing on the first image data stored in the first image file to generate second image data and replacing the first image data in the first image file with the generated second image data. Also, in the second embodiment, since the mask data output instruction is included, the control unit 101 generates mask data in which the pixel positions of the object editing area are represented by 1 and the pixel positions of the remaining area are represented by 0, in addition to the second image file, and stores the mask data in the working memory 105.

Then, when it is determined in step S204 that the depth map needs updating, the control unit 101, in step S906, generates a new depth map corresponding to the image in the second image file which is limited to the object editing area, based on the mask data. In the second embodiment, depth estimation is performed by utilizing a depth estimation model that does not require prompts and that is stored in advance by the control unit 101 in the nonvolatile memory 104. The depth estimation model is a model that is pretrained to perform depth estimation of a limited range using mask data. The control unit 101 reads out the file structure information, the second image file, and the mask data indicating the object editing area, and performs depth map estimation limited to the object editing area based on the read mask data. Furthermore, the control unit 101 generates an updated second depth map by reflecting the estimated depth map of the object editing area in the original first depth map, and generates an image file (third image file) that stores the second image data and the second depth map.

In step S908, the control unit 101 records an image file on which object editing processing has been performed to the recording medium 108. Specifically, if the depth map has been updated, the third image file is recorded, and if the depth map has not been updated, the second image file is recorded.

When the image file is recorded to the recording medium 108, the series of processing for object editing is ended.

According to the second embodiment as described above, it becomes possible to automatically update the map data when the user edits an object in an image.

### Third Embodiment

Next, a third embodiment of the present disclosure will be described.

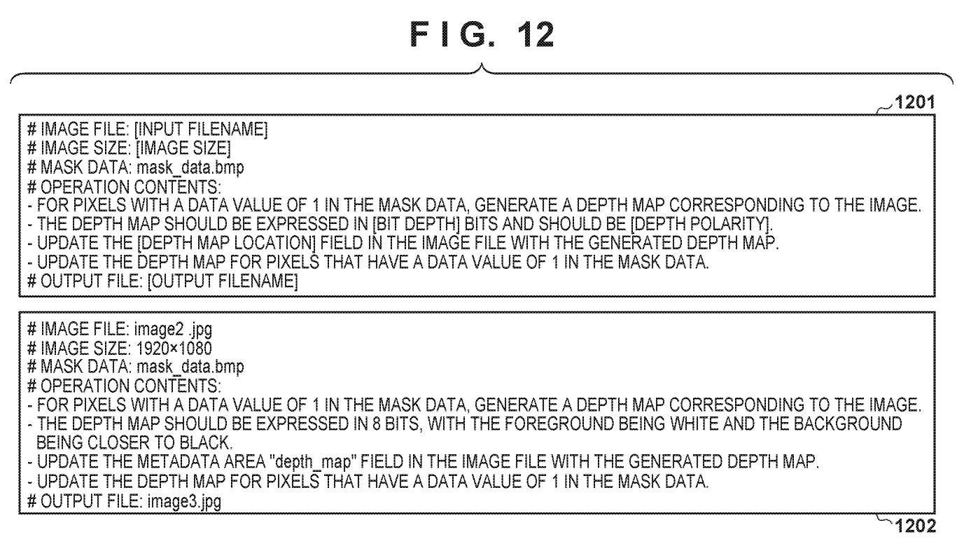

An example of a digital camera 100 in a third embodiment will be described with reference to FIGS. 11 and 12, focusing on the differences from the first embodiment. Note that since the configuration of the digital camera 100 in the third embodiment is similar to that described in the first embodiment with reference to FIG. 1, description thereof is omitted. The third embodiment is a combination of the first embodiment and the second embodiment. That is, in the third embodiment, an object editing prompt is created using the template 1001 shown in FIG. 10, and processing for updating the depth map is implemented based on a depth map updating prompt described later.

FIG. 11 is a flowchart showing a series of processing for object editing in the digital camera 100, with the processing being realized by the control unit 101 executing a program saved in advance to the nonvolatile memory 104. Also, in the following description, intermediate data that is handled in each step is assumed to be held in the working memory 105, and the control unit 101 is assumed to be able to freely access this data. Also, the same step numbers are given to processing that is the same as the processing shown in FIG. 2 described in the first embodiment and the processing shown in FIG. 9 described in the second embodiment, and description thereof is omitted.

In step S1105, the control unit 101 generates a depth map updating prompt. A difference from the first embodiment is that instruction contents for limiting the area targeted for updating that is based on mask data are included, in addition to a depth map update instruction. FIG. 12 shows an example of the depth map updating prompt.

In FIG. 12, reference numeral 1201 denotes a template for the depth map updating prompt, and reference numeral 1202 denotes an example of a prompt obtained by reflecting the processing contents in the template 1201. In the third embodiment, a prompt for processing that utilizes mask data is included in the depth map editing prompt of the template.

In step S1106, the control unit 101 performs depth map update processing.

Here, a difference from the first embodiment is that mask data indicating an object change area is input.

In the third embodiment, depth estimation is performed by the control unit 101 utilizing a depth estimation model that is based on a prompt and that is stored in advance in a nonvolatile memory 104. The depth estimation model is a model that is pretrained to perform depth estimation of a limited range using mask data. The control unit 101 reads out the file structure information, the second image file, and the mask data indicating the object editing area, and performs depth map estimation limited to the object editing area based on the read mask data. Furthermore, the control unit 101 generates an updated second depth map by reflecting the estimated depth map of the object editing area in the original first depth map, and generates an image file (third image file) that stores the second image data and the second depth map.

According to the third embodiment as described above, it becomes possible to automatically update the map data when the user edits an object in an image.

### Variation

In the third embodiment described above, the case where an instruction for generating mask data is included in the object editing prompt is described, but an instruction for generating mask data may also be included in the depth map editing prompt. In that case, the instruction relating to mask data generation of “# operation contents” in FIG. 10 need only be included at the beginning of “# operation contents” in FIG. 12.

Although mask data is thereby generated in step S1106 before the above-described processing is performed, instead of mask data being generated in step S903 of FIG. 11, it becomes possible to automatically update the map data when the user edits an object in an image, similarly to the third embodiment.

### Other Embodiments

Note that the present disclosure may be applied to a system constituted by a plurality of devices or to an apparatus consisting of a single device.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-036695, filed March 7, 2025 which is hereby incorporated by reference herein in its entirety.

What is claimed is:

1. An image processing apparatus comprising:
a generating unit that generates first instruction information for instructing object editing with respect to an image;
an editing unit that performs object editing based on the first instruction information with respect to first image data, and generates second image data; and
an updating unit that updates first map data corresponding to the first image data so as to correspond to the second image data generated by the editing unit.

2. The image processing apparatus according to claim 1,
wherein the updating unit updates the first map data, based on area data, by replacing a value of an area, within the first map data, where the first image data differs from second image data with a value of second map data,
wherein the area data represents, for each predetermined area, whether the first image data is identical to the second image data, and
wherein the second map data corresponds to the second image data.

3. The image processing apparatus according to claim 2,
wherein the generating unit generates second instruction information indicating an instruction for updating the first map data so as to correspond to the second image data, and
the updating unit, based on the second instruction information:
generates the second map data corresponding to the second image data, and
generates the area data.

4. The image processing apparatus according to claim 2,
wherein the generating unit generates second instruction information indicating an instruction for updating the first map data so as to correspond to the second image data, and
the updating unit, based on the second instruction information:
generates the area data, and
generates the second map data corresponding to the second image data, based on the area data, for an area, within the first map data, where the first image data differs from the second image data.

5. The image processing apparatus according to claim 2,
wherein the first instruction information further includes an instruction for generating the area data, and
the updating unit:
generates the area data based on the first instruction information, and
generates the second map data corresponding to the second image data, based on the area data, for an area where the first image data differs from the second image data.

6. The image processing apparatus according to claim 2,
wherein the generating unit generates second instruction information indicating an instruction for updating the first map data so as to correspond to the second image data,
the first instruction information further includes an instruction for generating the area data, and
the updating unit:
generates the area data based on the first instruction information, and
generates the second map data corresponding to the second image data, based on the second instruction information and the area data, for an area where the first image data differs from the second image data.

7. The image processing apparatus according to claim 2,
wherein the predetermined area is each pixel.

8. The image processing apparatus according to claim 1,
wherein the first map data is at least one of a depth map, a distance map, a normal map, and a segmentation map.

9. The image processing apparatus according to claim 2,
wherein the updating unit analyzes a map data format of the first map data and generates the second map data according to the map data format.

10. The image processing apparatus according to claim 3, further comprising:
a determining unit that determines whether to update the first map data, based on contents of the first instruction information,
wherein the generating unit generates the second instruction information, if it is determined by the determining unit to update the first map data.

11. The image processing apparatus according to claim 10,
wherein the determining unit determines not to update the first map data, if the first instruction information instructs only editing of an object not having depth information with respect to the image.

12. The image processing apparatus according to claim 4, further comprising:
a determining unit that determines whether to update the first map data, based on contents of the first instruction information,
wherein the generating unit generates the second instruction information, if it is determined by the determining unit to update the first map data.

13. The image processing apparatus according to claim 12,
wherein the determining unit determines not to update the first map data, if the first instruction information instructs only editing of an object not having depth information with respect to the image.

14. The image processing apparatus according to claim 6, further comprising:
a determining unit that determines whether to update the first map data, based on contents of the first instruction information,
wherein the generating unit generates the second instruction information, if it is determined by the determining unit to update the first map data.

15. The image processing apparatus according to claim 14,
wherein the determining unit determines not to update the first map data, if the first instruction information instructs only editing of an object not having depth information with respect to the image.

16. The image processing apparatus according to claim 5, further comprising:
a determining unit that determines whether to update the first map data, based on contents of the first instruction information,
wherein the updating unit updates the first map data, if it is determined by the determining unit to update the first map data.

17. The image processing apparatus according to claim 16,
wherein the determining unit determines not to update the first map data, if the first instruction information instructs only editing of an object not having depth information with respect to the image.

18. The image processing apparatus according to claim 1,
wherein the editing unit utilizes image generation AI to perform the object editing.

19. An image capturing apparatus comprising:
an image processing apparatus comprising:
a generating unit that generates first instruction information for instructing object editing with respect to an image;
an editing unit that performs object editing based on the first instruction information with respect to first image data, and generates second image data; and
an updating unit that updates first map data corresponding to the first image data so as to correspond to the second image data generated by the editing unit; and
an image capturing unit that captures an image.

20. An image processing method comprising:
generating first instruction information for instructing object editing with respect to an image;
performing object editing based on the first instruction information with respect to first image data, and generating second image data; and
updating first map data corresponding to the first image data so as to correspond to the second image data.

21. A non-transitory computer-readable storage medium, the storage medium storing a program that is executable by the computer, wherein the program includes program code for causing the computer to function as an image processing apparatus comprising:
a generating unit that generates first instruction information for instructing object editing with respect to an image;
an editing unit that performs object editing based on the first instruction information with respect to first image data, and generates second image data; and
an updating unit that updates first map data corresponding to the first image data so as to correspond to the second image data generated by the editing unit.
